(19) United States
(12) Patent Application Publication
(10) Pub. No.: US 2012/0164319 A1
(43) Pub. Date: Jun. 28, 2012

(54) Method of Forming a Metal Phosphate Coated Cathode for Improved Cathode Material Safety

(76) Inventors: Christopher M. Lang, Haverhill, MA (US); Aron Newman, Cambridge, MA (US)

(21) Appl. No.: 13/329,839

(22) Filed: Dec. 19, 2011

Related U.S. Application Data
(60) Provisional application No. 61/425,611, filed on Dec. 21, 2010.

(51) Int. Cl. B05D 5/12

(52) U.S. Cl. 427/126.6; 427/126.1; 427/126.3

(57) ABSTRACT

The invention features a method of forming a metal phosphate coated cathode. Either a metal salt or a phosphate salt is dissolved in a nonaqueous solvent to form a first solution. The other of the metal salt or the phosphate salt (e.g., whichever compound is not dissolved in the nonaqueous solvent) is dissolved in a second solvent to form a second solution. The first solution and the second solution are mixed to form a precursor solution. A cathode material is added to the precursor solution to form a cathode-precursor solution. The cathode-precursor solution is dried to form the metal phosphate coated cathode.

### RELATED APPLICATIONS

This application claims the benefit of and priority to U.S. Provisional Application No. 61/425,611, filed Dec. 21, 2010, which is owned by the assignee of the instant application and the disclosure of which is incorporated herein by reference in its entirety.

### STATEMENT OF GOVERNMENT INTEREST

The invention was made with government support under National Aeronautics and Space Administration (“NASA”), Glen Research Center contract no. NNC09CA04C. The government may have certain rights in the invention.

### FIELD OF THE INVENTION

The invention relates generally to a method of forming a cathode material, and more particularly to a method of forming a metal phosphate coated cathode material for improved cathode material safety.

### BACKGROUND OF THE INVENTION

Metal oxide cathode materials can be stabilized through a coating layer. A cathode is a positive electrode material that can be used in a lithium ion cell (a type of rechargeable cell in which lithium ions move from the negative electrode (anode) to the positive electrode (cathode) during discharge and from the cathode to the anode during charge) from which lithium ions and electrons flow during cell charging. Ions and electrons are returned to the structure during cell discharge. Charging is a process of supplying electrical energy for conversion to stored chemical energy. In this process, for example, lithium ions and electrons are removed from the cathode structure and stored in the anode. Discharge is a conversion process of chemical energy of a battery into electrical energy.

The coating used to stabilize the metal oxide cathode materials can be designed to prevent highly oxidized metal particles from decomposing the electrolyte, which can result in capacity loss and gas generation. Coatings can be made from metal oxides, such as, for example, titanium dioxide (“TiO₂”) or zirconium oxide (“ZrO₂”), and can increase stability of the cathode material. Typically, during the formation of the coatings, water or an aqueous solution/solvent is used. The use of water during the formation of these coatings can lead to lithium (“Li”) dissolution resulting in the precipitation of lithium salts on the surface, which can swell during storage at higher temperatures. Similarly, metal fluoride coatings can stabilize the cathode and improve cycling; however, as with the oxide coatings, these materials are not known as cathode materials and therefore can have limited lithium conductivity. In contrast, metal phosphates are particularly appealing as they are cathode materials themselves (and therefore lithium ion conductors) at higher potentials than their metal oxide counterparts. A metal phosphate is a compound composed of a phosphate anion (“Pal”) and a metal cation. Examples of metal phosphates include cobalt phosphate, iron phosphate, etc. However, conventional processes for applying metal phosphate layers utilize prepared, discrete precursor particles or water that can lead to incomplete coverage and/or lithium dissolution.

### SUMMARY OF THE INVENTION

The invention, in various embodiments, features a method of forming a metal phosphate coated cathode that limits the amount of water used during the formation process. The use of a nonaqueous solvent to form a metal phosphate coated cathode can decrease or substantially eliminate the precipitation of lithium salts on the surface as well as the swelling that can occur during storage at higher temperatures. Moreover, the invention, in various embodiments, features a method that leads to the complete coverage of a metal phosphate on a cathode material.

In one aspect, the invention features a method of forming a metal phosphate coated cathode. Either a metal salt or a phosphate salt is dissolved in a nonaqueous solvent to form a first solution. A metal salt is an ionic compound composed of an anion and metal cation. Examples of metal salts include cobalt acetate, cobalt nitrate, nickel nitrate, etc. Nonaqueous refers to non-water based solvents such as, for example, isopropanol, N-methyl-2-pyrrolidone (“NMP”), or ethanol. In some embodiments, nonaqueous refers to a system without water present. The other of the metal salt or the phosphate salt (e.g., whichever compound is not dissolved in the nonaqueous solvent) is dissolved in a second solvent to form a second solution. The first solution and the second solution are mixed to form a precursor solution. A cathode material is added to the precursor solution to form a cathode-precursor solution. The cathode-precursor solution is dried to form the metal phosphate coated cathode.

In another aspect, the invention features a metal phosphate coated cathode that is formed by a process including dissolving either a metal salt or a phosphate salt in a nonaqueous solvent to form a first solution. The other of the metal salt or the phosphate salt is dissolved in a second solvent to form a second solution. The first solution and the second solution are mixed to form a precursor solution. A cathode material is added to the precursor solution to form a cathode-precursor solution. The cathode-precursor solution is dried to form the metal phosphate coated cathode.

In yet another aspect, the invention features a battery, including an anode and a cathode. The cathode is formed by dissolving either a metal salt or a phosphate salt in a nonaqueous solvent to form a first solution. The other of the metal salt or the phosphate salt is dissolved in a second solvent to form a second solution. The first solution and the second solution are mixed to form a precursor solution. A cathode material is added to the precursor solution to form a cathode-precursor solution. The cathode-precursor solution is dried to form the metal phosphate coated cathode. Cathode electrodes can be formed in a standard manner such as by casting a suspension of the cathode particles, binder, and/or conductor on a current collector. The battery also includes a separator and nonaqueous electrolyte disposed between the and cathode electrodes. In some embodiments, nonaqueous refers to a system without water present. In some embodiments, the battery is a lithium-ion battery. The lithium-ion battery can be rechargeable.

In some embodiments, the metal salt is dissolved in the nonaqueous solvent and the phosphate salt is dissolved in the second solvent. The metal salt and the phosphate salt can be dissolved in nonaqueous solvent. In some embodiments the nonaqueous solvent is isopropanol. The metal salt can be dissolved in isopropanol and the phosphate salt is dissolved in water. The nonaqueous solvent can be N-methyl-2-pyrrolidone. In some embodiments, the metal salt is dissolved in N-methyl-2-pyrrolidone and the phosphate salt is dissolved in water.

The metal salt can be cobalt nitrate; cobalt acetate, cobalt sulfate, nickel nitrate, nickel acetate, or aluminum nitrate. The phosphate salt can be ammonium hydrogen phosphate. In some embodiments, the metal salt is a mixture of metal salts. For example, a mixture of cobalt nitrate and nickel nitrate, cobalt nitrate and aluminum nitrate, or cobalt nitrate, nickel nitrate, and manganese nitrate can be used. Other mixtures of metal salts can also be used, for example, combinations of aluminum, cobalt, iron, and/or manganese, etc.

In some embodiments, the method also includes using a shear mixer to mix the first and second solutions. Other mixers can be used that are capable of achieving and/or maintaining similar particle size distribution and settling time as a shear mixer.

The cathode material can be a cathode powder. In some embodiments, the cathode material is a lithium metal oxide. A lithium metal oxide is an inorganic material of the chemical formula LiₓM_{y}O₂ which is typically utilized as the cathode material in a lithium ion cell. M can represent a single metal species of combinations of metal species such as cobalt (“Co”), nickel (“Ni”), manganese (“Mn”), etc. Examples of lithium metal oxides include lithium cobalt oxide (“LiCoO₂”) or lithium nickel cobalt aluminum oxide (“LiNiₓCo_{y}Al_{z}O₂”). The lithium metal oxide can also be lithium nickel cobalt manganese oxide.

### BRIEF DESCRIPTION OF THE DRAWINGS

FIG. 1 is a scanning electron microscope (SEM) image of a cobalt phosphate particle, according an illustrative embodiment of the invention.

FIG. 2 is a voltage versus discharge capacity plot for intermittent discharge cycles for a phosphate coated electrode subjected to 200 cycles, according an illustrative embodiment of the invention.

FIG. 3 is a magnified view of the voltage versus discharge capacity data shown in FIG. 2, according an illustrative embodiment of the invention.

FIG. 4 is a plot of a differential scanning calorimeter (“DSC”) heat flow versus temperature (e.g., exothermic energy release) for a delithiated dry cathode having no coating, 0.5% phosphate coating, and 1% phosphate coating, according to an illustrative embodiment of the invention.

FIG. 5 is a plot showing the results of DSC testing for the coating of TODA MNC-9100 cathode material, according to an illustrative embodiment of the invention.

FIG. 6 is a plot showing the results of variable cycling tests for full cells utilizing an optimized coated cathode, according to an illustrative embodiment of the invention.

### DESCRIPTION OF THE INVENTION

The problem of efficiently and safely cycling cathode (positive electrode) materials in a lithium-ion cell can be solved by the in-situ growth of a lithium metal phosphate coating, which serves to stabilize the lithium metal oxide structures as well as minimize spontaneous reactions with the electrolyte. For example, lithium metal phosphate coating layers can be applied to lithium metal oxide cathode materials. More specifically, lithium cobalt phosphate (“LiCoPO₄”) coatings formed on lithium cobalt oxide (“LiCoO₂”) can result in partial to complete suppression of the exotherm observed on heating LiCoO₂ while still providing comparable electrochemical performance to the uncoated material. Coating of layered metal oxide materials can cause the exotherm onset temperature to shift to higher temperatures and the discharge capacity and rate performance to improve. To provide optimal safety and rate performance, the coating procedure can be optimized for individual cathode materials. This optimization can include adjusting the metal in the lithium metal phosphate layer, as well as varying the phosphate precursor and final lithium metal phosphate concentration.

The cathode materials can be used in rechargeable lithium-ion cells and batteries. In particular, the thermal stability of lithium metal oxide cathode materials can be improved, and spontaneous reactions with the electrolyte upon charging of a cell can be reduced, when the cathode material is coated with a metal phosphate. In addition, the operating voltage range of the cathode material can be extended, thereby increasing the energy density of a constructed cell.

An in-situ process can be used to form a conformal lithium metal phosphate coating on lithium metal oxide cathode materials. This process of coating cathode materials with lithium metal phosphate layers can improve the safety and performance of the cathode. The coating process includes the steps of salt dissolution, precursor formation, precursor/cathode combination, and heat treatment/drying.

In general, the appropriate metal salt, or mixed metal salt, for the desired final lithium metal phosphate coating can be dissolved in a nonaqueous solvent to form a first solution. The use of a nonaqueous solvent minimizes the water content in the formed metal phosphate particle limiting lithium dissolution and improving the overall thermal stability of the final material. Similarly, an aqueous solution can be formed with an appropriate phosphate salt to form a second solution. In some embodiments, the phosphate salt is dissolved in the nonaqueous solvent and the metal salt is dissolved in the aqueous solvent. In some embodiments, both the phosphate salt and the metal salt are dissolved in nonaqueous solvents.

Next, a precursor (e.g., a metal phosphate precursor solution) solution can be formed by mixing stoichiometric amounts of the first and second solutions together in a mixer, for example, a high speed shear mixer, minimizing the final particle size and thereby improving the final coverage. In some embodiments, non-stoichiometric amounts of the first and second solutions are mixed together in a mixer. Immediately upon completion of mixing, the amount of cathode material necessary to give the desired final phosphate layer loading is added to the slurry and mixed once more to form a cathode-precursor solution (e.g., a uniform cathode/metal phosphate slurry). Upon complete mixing, the slurry is dried, for example, at 50° C., to remove residual solvent and mixed again to ensure uniform distribution. The resulting powder can be dried under vacuum, pressed into a pellet, and heat treated under air. The final product is a metal phosphate coated cathode (e.g., a cathode powder with similar morphology to the uncoated cathode material.)

More specifically, the first step, salt dissolution, involves forming two solutions by dissolving the desired metal and phosphate salts in their respective solvents. Either the metal salt or the phosphate salt is dissolved in a nonaqueous solution (e.g., isopropanol or N-methyl-2-pyrrolidone). The other of the metal salt or the phosphate salt that is not dissolved in the nonaqueous solution is dissolved in a second solvent (e.g., water). In some embodiments, both the metal salt and the phosphate salt are dissolved in a nonaqueous solution. For example, to form a lithium cobalt phosphate layer, cobalt nitrate can be dissolved in isopropanol. The use of a nonaqueous solvent minimizes the water content in the lithium metal phosphate precursor that is formed in the next step. Similarly, ammonium hydrogen phosphate can be dissolved in water to form a second solution. For example, 0.1 moles of cobalt (II) nitrate can be dissolved in 1 liter of anhydrous isopropanol while 2 moles of ammonium hydrogen phosphate can be dissolved in 1 liter of water. The term anhydrous refers to a solvent containing, for example, less than about 100 ppm of water. In some embodiments, the metal salt is dissolved in N-methyl-2-pyrrolidone and the phosphate salt is dissolved in water.

The metal of the coating can be varied by using additional metals, including but not limited to, nickel, aluminum, or manganese. Therefore, the lithium metal oxide cathode material can be, for example, lithium cobalt oxide, lithium nickel cobalt aluminum oxide, or lithium nickel cobalt manganese oxide. Likewise the metal salt can utilize additional anions such as, for example, acetates, bromides, chlorides or sulfates. Therefore, the metal salt can be, for example, cobalt nitrate or cobalt acetate.

Next, the two solutions can be mixed to form a precursor solution. For example, metal phosphate particles can be formed by mixing together the two solutions such that the final mixture contains three moles of metal salt for every two moles of phosphate. A shear mixer can be used, such as Physical Sciences Inc.'s FlackTek DAC 150FVZ Speedmixer, which results in small particle sizes and long settling times. Conventional mixing on a stir plate with or without dropwise addition of the components can result in particles that rapidly precipitate. In the prior example, 0.94 ml of the cobalt solution and 0.03 ml of the ammonium hydrogen phosphate solution can be added to a Speedmixer container with 2-3 5 mm ceramic milling media per 5-10 ml of solution and spun at 3450 RPM for 5 minutes. During the mixing process the phosphate anion exchanges with the anion of the soluble metal salt producing an insoluble metal phosphate that precipitates from solution. As this precipitate becomes significant it crashes into the milling media eventually producing a distinguishable grinding sound. For example, for the baseline sample previously described “grinding” of the particles was noted after approximately 2 minutes of mixing. On completion of the 5 minute mixing, the particles are dispersed throughout the solution giving a hazy appearance.

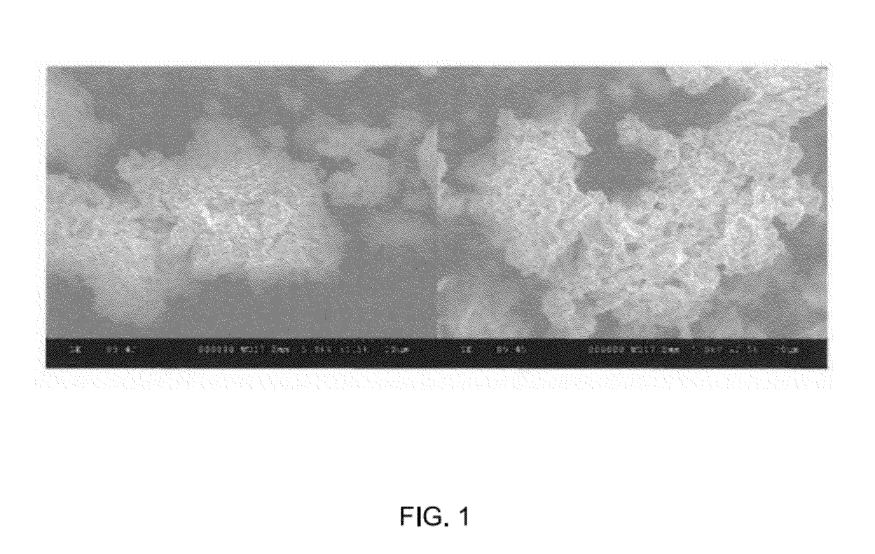

FIG. 1 shows a scanning electron microscope (SEM) image of cobalt phosphate particles formed as described above. The light spots in the image show large particles with considerable microstructure suggesting an agglomeration of smaller particles. This agglomeration in part occurs on drying and is minimized under the high speed mixing conditions. The final size of the particles can be varied by adjusting the solvents, salts, and/or their concentrations. For example, the size of the particles can be between about 10 nm and about 10 microns

Immediately following precursor formation, the desired amount of cathode material (e.g., in the form of a powder) can be added to the solution and mixed again for about 5 minutes at about 3450 RPM to form a cathode-precursor solution. This mixing step uniformly disperses the metal phosphate particles throughout the cathode particles.

Following mixing, the slurry can be dried to form the metal phosphate coated cathode. For example, the slurry can be placed in a 50° C. oven in order to dry off the excess solvent. The impact of any particle settling can be minimized by stirring up the solution in approximately 5 minutes intervals until sufficiently dry. Once the majority of the solvent is removed, the powder can be dried at approximately 120° C. for about 4 hours. The drying can be performed for longer and/or under vacuum, however, as 120° C. is insufficient to significantly impact the crystal structure such changes are not anticipated to impact the final phosphate crystal structure. The dry powder can then be pressed into a pellet and cooked in air by ramping to about 800° C. at 2° C./min. The sample can be held at approximately 800° C. for about 8 hours before program termination and cooling back to room temperature. Depending on the cathode material, adjustments in the annealing temperature/time can be necessary to maintain the initial cathode structure. Once annealing is completed, the powder can be broken up and collected to form electrodes for testing.

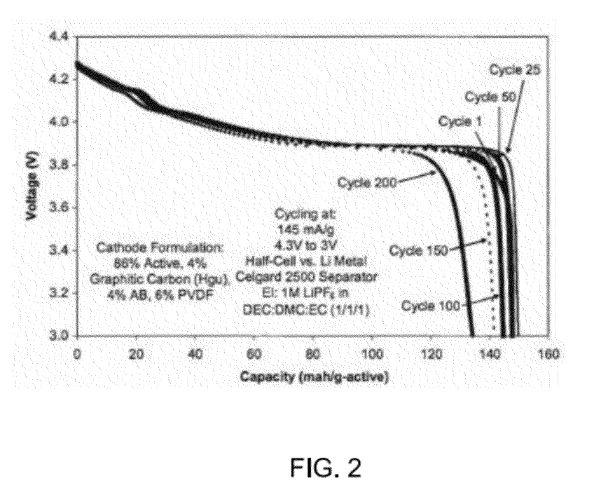

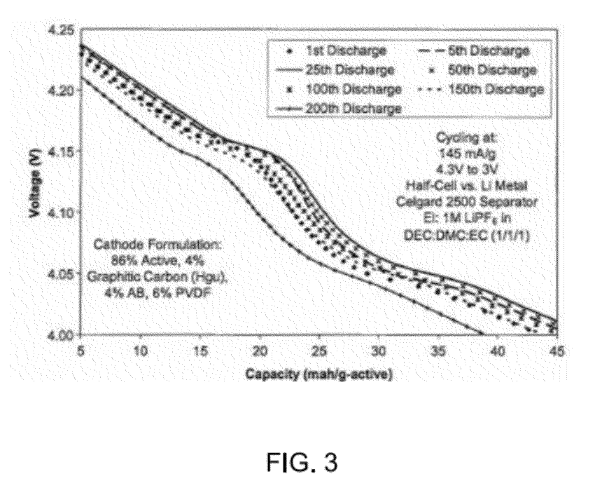

Following annealing and collection, the coated cathode can be prepared into an electrode utilizing common processing techniques with no adjustment for the phosphate coating. FIG. 2 is a voltage versus discharge capacity plot for intermittent discharge cycles for a phosphate coated electrode subjected to 200 cycles. FIG. 3 is a magnified view of the voltage versus discharge capacity data shown in FIG. 2. Referring to FIG. 2, the plot shows traces of the cell voltage versus discharge capacity at various cycle increments for a 200 cycle constant current experiment. After 200 cycles, the cathode still retained greater than about 89% of its discharge capacity. Further, on examination of the 4 to 4.25 V range (FIG. 3), the voltage peak around 4.15 V that is reported to accompany the transition from a disordered to ordered state are still present indicating a stabilization of the material by the coating.

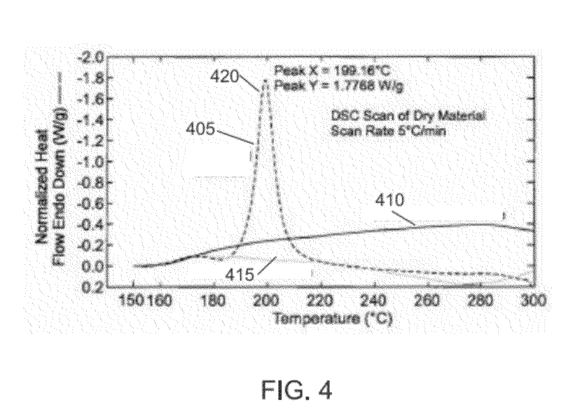

The impact of the coating on the thermal stability of the cathode was tested by building test cells and charging the cells so as to delithiate the cathode. Delithiated refers to a cathode material from which the lithium ions have been electrochemically removed. The removal of the lithium occurs during the charging process of a battery. Once delithiated, the cathode was harvested and the material punched and placed in a DSC test fixture. The DSC device measures temperatures and heat flows associated with thermal transitions in a material. Delithiation of the cathode material destabilizes the structure, potentially leading to an exothermic release of oxygen which can then react with the fuel. FIG. 4 is a plot of DSC heat flow versus temperature (e.g., exothermic energy release) for a delithiated dry cathode having no coating 405, 0.5% phosphate coating 410, and 1% phosphate coating 415. For the uncoated sample 405 a distinct peak 420 is noted, which on coating with 0.5% phosphate 410 is reduced. Further, increasing the phosphate coating to 1% 415 results in the complete suppression of the exothermic peak 420. This increased cathode stability can minimize the oxygen released during overcharge and thus minimize the potential for catastrophic battery failure.

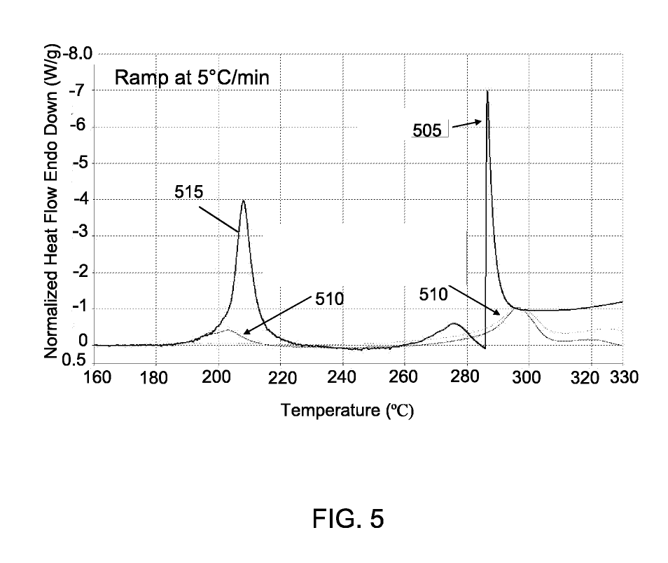

FIG. 5 is another example showing the results of DSC testing for the coating of TODA's MNC-9100 cathode material. This cathode material is an overlithiated manganese-nickel-cobalt oxide cathode material offering high discharge capacity. The plot shows the heat flow versus temperature for dry, delithiated uncoated 505 and 0.75% coating (equal Co/phosphate) 510 MNC-9100 cathode material (e.g., the optimized coated cathode). For the lower concentration coating, the coating eliminates the peak around 275° C. and reduces the peaks around 205° C. and 290° C. to below −2 W/g. In contrast, the largest peak exotherm for the optimized coating 510 is −1 W/g and is located at 295° C. or 5 to 10° C. higher in temperature than the third (and largest) peak for the uncoated sample 505. Further, at −1 W/g the peak is significantly smaller than either of the two large peaks 505, 515 (−4 and −7 W/g) for the uncoated sample. This is consistent with other testing which showed no exotherms above −1 W/g. 1.5 kg of cathode material was successfully coated and delivered using this formulation.

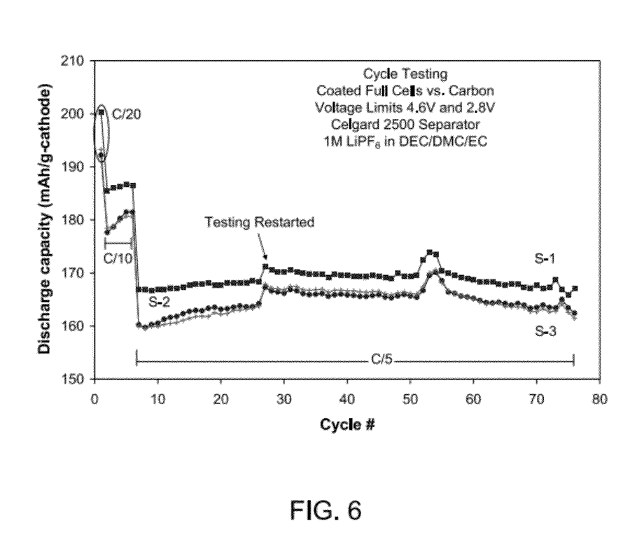

FIG. 6 shows the results of variable cycling tests for full cells utilizing the optimized coated cathode (e.g., the 0.75% coating (equal Co/phosphate) cathode as discussed with respect to FIG. 5). The plot shows discharge capacity versus cycle number for variable rate cycling of full cells using coated MNC-9100 cathode material. The slight variations in the capacity values are due to the use of a carbon anode and the slight variation in the cathode to anode ratios. Each cell was initially cycled for 26 cycles (C/20, C/10×5, C/5×20). On test completion an additional 50 cycles were performed at C/5. On examining the results, the coated cells are seen to deliver between 180 and 185 mAh/g on C/10 cycling consistent with the results for the uncoated cells. At C/5 the capacity decreases to ˜165 mAh/g, however, after the 76^{th} cycle the capacity for each cell is equal or higher to the capacity on cycle 6. In contrast after 26 cycles each of the uncoated cells had a discharge capacity of 162 mAh/g or lower and in general the capacity was observed to decrease with cycle number.

### Example 1

The coating process for applying a 1% lithium cobalt phosphate coating was performed by the following process. First, 0.2 moles of cobalt (II) nitrate (Co(NO₃)₂*6H₂O, Aldrich #239267) were dissolved in 1 liter of anhydrous isopropanol (IPA). Two moles of ammonium hydrogen phosphate ((NH₄)₂HPO₄, Aldrich #215996) were dissolved in 1 liter of water.

0.47 ml of cobalt nitrate solution was mixed with 0.03 ml of ammonium hydrogen phosphate solution for each 1 g of cathode material to be formed. Immediately after mixing, the mixture was spin at 3540 RPM (max speed) for 5 minutes using a FlackTek DAC 150FVZ Speedmixer with 2-3 5 mm ceramic milling media per 5-10 ml of solution. Immediately upon completion of mixing, 0.99 g of cathode material was added to the mixture and the mixture was spin again for 5 minutes.

The mixture was removed from the FlackTek DAC 150FVZ Speedmixer and allowed to dry for 2-3 hours (e.g., until the majority of the solvent was removed) at 50° C. in an oven to prevent solvent boiling. At 45 minute intervals (and the drying slurry is transferred to a vacuum oven), the drying slurry is removed from the oven and mixed for 30 seconds using the speedmixer.

The drying slurry was transferred to a vacuum oven at 120° C. for 4 hours and then pressed into a pellet and cooked in air by ramping the vacuum oven to 800° C. at 2° C./min and holding for 8 hours. Once the oven had cooled, the powder was removed and the pellet was broken up. To ensure minimal aggregation, the dry powder was passed through 38 micron metal mesh storing the final fine powder in a sealable container in a dry atmosphere.

Pouch cell electrodes were made by using 88% active cathode material, 5% acetylene black, and 7% Kynar's Power Flex polyvinylidene fluoride (“PVDF”). A 60% solids loading was utilized with the remainder of the slurry NMP. After mixing, the slurry was cast on aluminum using a doctor blade and dried under vacuum at about 120° C.

### Example 2

The coating process for applying a 1% lithium cobalt phosphate coating was also performed by the following process. 0.1 M cobalt (II) nitrate (Co(NO₃)₂*6H₂O, Aldrich #239267) was dissolved in isopropanol (IPA, preferably anhydrous). 2 M ammonium hydrogen phosphate ((NH₄)₂HPO₄, Aldrich #215996) was dissolved in water.

0.93 ml of cobalt nitrate solution was mixed with 0.03 ml of ammonium hydrogen phosphate solution for each 1 g of cathode material to be formed. Immediately after mixing, the mixture was spun at 3540 RPM (max speed) for 5 minutes using a FlackTek DAC 150FVZ Speedmixer with 2-3 5 mm ceramic milling media per 5-10 ml of solution. Immediately upon completion of mixing, 0.99 g of cathode material was added to the mixture and the mixture was spun again for 5 minutes.

The mixture was removed from the mixer and allowed to dry 1-2 hours (e.g., until the majority of the solvent is removed) at 50° C. to prevent solvent boiling. The mixture was transferred to an oven at 120° C. for 4 hours. It was then pressed into a pellet and cooked in air by ramping the oven to 800° C. at 2° C./min and holding for 8 hours. Once the oven had cooled, the powder was removed, the pellet broken up and stored in dry atmosphere.

Electrodes were made by using 86% active cathode material, 4% acetylene black, 4% HgU (a platelet ˜1 μm graphite), and 6% Kynar's Power Flex PVDF. 0.5 g solids were dissolved in 0.72 g of NMP. After mixing, the slurry was cast on aluminum using a doctor blade and dried under vacuum at about 120° C.

### Example 3

Applying a 1.5% coating to a range of cathode powders was carried out using the following method. 27.7 g of Co(NO₃)₂*6H₂O was dissolved in 1 L of NMP. 66 g of (NH₄)₂HPO₄ was dissolved in 1 L of water. 0.701 g of cobalt nitrate solution was weighed out per gram of cathode powder. 0.135 g of phosphate solution was also weighed out per gram of cathode powder. The nitrate and phosphate solutions were mixed using a shear mixer (or similar high speed mixer) for 30 seconds at max speed. After waiting about 30 seconds, the solutions were mixed again for 5 minutes at max speed. In a separate container, 0.75 mL of the phosphate and nitrate liquid mixture was added for every gram of cathode powder. The slurry was mixed at max speed for 30 seconds. The container was vented to release any built up gas. The slurry was mixed again for 1 minute at max speed. The contained was vented again. The mixing and venting of the slurry mixture was repeated a third time. The mixture was placed in a convection oven at 85° C. The powder was left in the oven until the remainder of the liquid evaporated and the powder was dry.

Heat treatment of the powder was performed by using the following method. The dry coated cathode was packed into a crucible and placed in a furnace at 100° C. for 60 minutes. The furnace was ramped at 2° C./min to 800° C. The furnace was held at 800° C. for 8 hours. The furnace was cooled naturally.

Electrodes were formed using the same slurry recipes as for the uncoated cathode powders. For example electrodes were formed using 90% active cathode material, 5% acetylene black, and 5% Kynar's HSV PVDF. A 50% solids loading was utilized with the remainder of the slurry NMP. After mixing, the slurry was cast on aluminum using a doctor blade and dried under vacuum at about 90° C.

### Example 4

Applying a 0.75% coating to a range of cathode powders was performed using the following method. 27.7 g of Co(NO₃)₂*6H₂O was dissolved in 1 L of NMP. 66 g of (NH₄)₂HPO₄ was dissolved in 1 L of water. 0.701 g of cobalt nitrate solution was weighed out per gram of cathode powder. 0.135 g of phosphate solution was also weighed out per gram of cathode powder. The nitrate and phosphate solutions was mixed using a shear mixer (or similar high speed mixer) for 30 seconds at max speed. After waiting 30 seconds, the solutions were mixed again for 5 minutes at max speed. In a separate container, 0.375 mL of the phosphate and nitrate liquid mixture was mixed for every gram of cathode powder. The slurry was mixed at max speed for 30 seconds. The container was vented to release any built up gas. The slurry was mixed again for 1 minute at max speed and the container was vented. The mixing and venting of the slurry mixture was repeated a third time. The slurry was placed in a convection oven at 85° C. The powder was left in the oven until the remainder of the liquid is evaporated and the powder was dry.

Heat treatment and electrode formation with the coated material can be performed as described in the previous examples.

### Example 5

Applying a 0.75% coating to a range of cathode powders was performed using the following method. 27.7 g of Co(NO₃)₂*6H₂O was dissolved in 1 L of NMP and 66 g of (NH₄)₂HPO₄ was dissolved in 1 L of water. 0.701 g of cobalt nitrate solution was weighed out per gram of cathode powder and 0.09 g of phosphate solution was weighed out per gram of cathode powder. The nitrate and phosphate solutions were mixed using a shear mixer (or similar high speed mixer) for 30 seconds at max speed. After waiting 30 seconds, the solutions were mixed again for 5 minutes at max speed. In a separate container, 0.345 mL of the phosphate and nitrate liquid mixture was added for every gram of cathode powder. The slurry was mixed at max speed for 30 seconds. The container was vented to release any built up gas. The slurry was mixed again for 1 minute at max speed and the container was vented again. The mixing and venting of the slurry mixture was repeated a third time. The slurry mixture was placed in a convection oven at 85° C. The powder was left in the oven until the remainder of the liquid evaporated and the powder was dry.

Heat treatment and electrode formation with the coated material can be performed as described in the previous examples.

### Example 6

Applying a 0.5% coating to a range of cathode powders was performed using the following method. 27.7 g of Co(NO₃)₂*6H₂O was dissolved in 1 L of NMP and 66 g of (NH₄)₂HPO₄ was dissolved in 1 L of water. 0.467 g of cobalt nitrate solution was weighed out per gram of cathode powder. 0.06 g of phosphate solution was also weighed out per gram of cathode powder. The nitrate and phosphate solutions were mixed using a shear mixer (or similar high speed mixer) for 30 seconds at max speed. After waiting 30 seconds, the solutions were mixed again for 5 minutes at max speed. In a separate container, 0.23 mL of the phosphate and nitrate liquid mixture was added for every gram of cathode powder. The slurry was mixed at max speed for 30 seconds. The container was vented to release any built up gas. The slurry was mixed again for 1 minute at max speed and the container was vented again. The mixing and venting of the slurry mixture was repeated a third time. The slurry was placed in a vacuum oven at 90° C. The powder was left in the oven until the remainder of the liquid evaporated and the powder was dry.

Heat treatment and electrode formation with the coated material can be performed as described in the previous examples.

### Example 7

Applying a 0.75% coating to a range of cathode powders was performed using the following method. 27.7 g of Ni(NO₃)₂*6H₂O was dissolved in 1 L of NMP and 66 g of (NH₄)₂HPO₄ was dissolved in 1 L of water. 0.701 g of nickel nitrate solution was weighed out per gram of cathode powder and 0.09 g of phosphate solution was weighed out per gram of cathode powder. The nitrate and phosphate solutions were mixed using a shear mixer (or similar high speed mixer) for 30 seconds at max speed. After waiting 30 seconds, the solutions were mixed again for 5 minutes at max speed. In a separate container, 0.345 mL of the phosphate and nitrate liquid mixture was added for every gram of cathode powder. The slurry was mixed at max speed for 30 seconds. The container was vented to release any built up gas. The slurry was mixed again for 1 minute at max speed and the container was vented again. The mixing and venting of the slurry mixture was repeated a third time. The slurry was place in a convection oven at 85° C. The powder was left in the oven until the remainder of the liquid is evaporated and the powder is dry.

Heat treatment and electrode formation with the coated material can be performed as described in the previous examples.

### Example 8

Applying a mixed metal phosphate coating to a range of cathode powers was performed using the following method. 13.5 g of Co(NO₃)₂*6H₂O and Ni(NO₃)₂*6H₂O were dissolved in 1 L of NMP and 66 g of (NH₄)₂HPO₄ was dissolved in 1 L of water. 0.701 g of metal nitrate solution was weighed out per gram of cathode powder and 0.09 g of phosphate solution was weighed out per gram of cathode powder. The nitrate and phosphate solutions were mixed using a shear mixer (or similar high speed mixer) for 30 seconds at max speed. After waiting 30 seconds, the solutions were mixed again for 5 minutes at max speed. In a separate container, 0.345 mL of the phosphate and nitrate liquid mixture was added for every gram of cathode powder. The slurry was mixed at max speed for 30 seconds. The container was vented to release any built up gas. The slurry was mixed again for 1 minute at max speed and the container was vented again. The mixing and venting of the slurry mixture was repeated a third time. The slurry was placed in a vacuum oven at 90° C. The powder was left in the oven until the remainder of the liquid evaporated and the powder was dry.

Heat treatment and electrode formation with the coated material can be performed as described in the previous examples.

### Example 9

Coating of the cathode was performed as previously described in the above examples. Heat treatment of the powder was performed by the following method. The dry coated cathode was packed into a crucible and placed in a furnace at 100° C. for 60 minutes. The furnace was ramped at 2° C./min to 600° C. The furnace was held at 600° C. for 8 hours. The furnace was left to cool naturally.

Electrode formation with the coated material can be performed as described in the previous examples.

### Example 10

Coating of the cathode was performed as previously described in the above examples. Heat treatment of the powder was performed by the following method. The dry coated cathode was packed into a crucible and placed in a furnace at 100° C. for 60 minutes. The furnace was ramped at 2° C./min to 400° C. The furnace was held at 400° C. for 8 hours. The furnace was left to cool naturally.

Electrode formation with the coated material can be performed as described in the previous examples.

### Example 11

Coating of the cathode was performed as previously described in the above examples. Heat treatment of the powder was performed by the following method. The dry coated cathode was packed into a crucible and placed in an argon filled furnace at 100° C. for 60 minutes. The furnace was ramped at 2° C./min to 600° C. The furnace was held at 600° C. for 8 hours. The furnace was left to cool naturally.

Electrode formation with the coated material can be performed as described in the previous examples.

### Example 12

Coating of the cathode was performed as previously described in the above examples. Heat treatment of the powder was performed by the following method. The dry coated cathode was packed into a crucible and placed in an argon filled furnace at 100° C. for 60 minutes. The furnace was ramped at 2° C./min to 400° C. The furnace was held at 400° C. for 8 hours. The furnace was left to cool naturally.

Electrode formation with the coated material can be performed as described in the previous examples.

Although various aspects of the disclosed method have been shown and described, modifications may occur to those skilled in the art upon reading the specification. The present application includes such modifications and is limited only by the scope of the claims.

What is claimed is:

1. A method of forming a metal phosphate coated cathode, comprising:
dissolving either a metal salt or a phosphate salt in a nonaqueous solvent to form a first solution;
dissolving the other of the metal salt or the phosphate salt in a second solvent to form a second solution;
mixing the first solution and the second solution to form a precursor solution;
adding a cathode material to the precursor solution to form a cathode-precursor solution; and
drying the cathode-precursor solution to form the metal phosphate coated cathode.

2. The method of claim 1 wherein the metal salt is dissolved in the nonaqueous solvent and the phosphate salt is dissolved in the second solvent.

3. The method of claim 1 wherein the metal salt and the phosphate salt are dissolved in nonaqueous solvent.

4. The method of claim 1 wherein the nonaqueous solvent is isopropanol.

5. The method of claim 1 wherein the metal salt is dissolved in isopropanol and the phosphate salt is dissolved in water.

6. The method of claim 1 wherein the nonaqueous solvent is N-methyl-2-pyrrolidone.

7. The method of claim 1 wherein the metal salt is dissolved in N-methyl-2-pyrrolidone and the phosphate salt is dissolved in water.

8. The method of claim 1 wherein the metal salt comprises at least one of cobalt nitrate; cobalt acetate, cobalt sulfate, nickel nitrate, nickel acetate, and aluminum nitrate.

9. The method of claim 1 wherein the phosphate salt is ammonium hydrogen phosphate.

10. The method of claim 1 further comprising using a shear mixer to mix the first and second solutions.

11. The method of claim 1 wherein the cathode material is a cathode powder.

12. The method of claim 1 wherein the cathode material is a lithium metal oxide.

13. The method of claim 12 wherein the lithium metal oxide is lithium cobalt oxide.

14. The method of claim 12 wherein the lithium metal oxide is lithium nickel cobalt aluminum oxide.

15. The method of claim 12 wherein the lithium metal oxide is lithium nickel cobalt manganese oxide.

16. The method of claim 1 wherein the metal salt is a mixture of metal salts.
